(19) United States
(12) Patent Application Publication
(10) Pub. No.: US 2026/0359207 A1
(43) Pub. Date: Nov. 12, 2026

(54) Hybrid Heuristic and Meta-Heuristic Parameter Value Search for Software Applications

(71) Applicant: Fusion Holdings Limited, Douglas (IM)

(72) Inventor: Ray Phillip Bosman, uMhlanga (ZA)

(21) Appl. No.: 19/207,656

(22) Filed: May 14, 2025

Related U.S. Application Data
(60) Provisional application No. 63/803,076, filed on May 9, 2025.

(51) Int. Cl. G06F 11/3668

(52) U.S. Cl. CPC G06F 11/3696

(57) ABSTRACT

Embodiments may involve generating sets of parameter values forming a parameter configuration space, each set comprises values for parameters of a system configuration associated with a software application; applying a set of input values to instances of the system configuration modified by each set of parameter values to identify corresponding output values; determining, for each set of parameter values based on the input values and corresponding output values, a respective input-value-to-output-value relationship, a respective variability, and a respective error; generating a test system configuration based a particular set of parameter values with a respective error below a threshold; applying a heuristic to modify the test system configuration until a test input-value-to-output-value relationship is within a first tolerance of a target input-value-to-output-value relationship and a test variability is within a second tolerance of a target variability; and causing a computing system to execute in accordance with the modified test system configuration.

### CROSS-REFERENCE TO RELATED APPLICATIONS

This application is a non-provisional of, and claims priority to, U.S. Provisional Pat. App. No. 63/803,076 filed May 9, 2025, which is hereby incorporated by reference herein in its entirety.

### BACKGROUND

Software applications, particularly those involved in providing, managing, and/or controlling complex dynamic systems or workflows found in a variety of technical applications, may utilize parameters. The values of these parameters control the behavior of such software applications and may be adjusted to adapt the behavior to different situations or performance requirements, for example. However, determining how to adjust parameters of a software application to achieve the desired behavior or outcome is technically challenging, given the vast number of possible combinations of parameter values.

Empirical testing of such systems (that is, altering values and running the software to see what happens and then collecting statistics on the results to fine tune the system) is time consuming and, in many cases because of the complexity of the systems, impractical. It may be impractical for other reasons, such as wasted materials, wear and tear on components, and/or cost, for example.

One approach that may be employed to adjust parameters of software applications is referred to as discrete optimization. Discrete optimization aims to find a “best” solution when faced with a large set possibilities. In this context, “best” is understood to be within an acceptable performance threshold, since it may be impossible to achieve a theoretical optimal result, at least using a reasonable amount of time and computational resources. The process of finding the “best” solution may also be referred to as a search. Such analysis may substantially improve development time and/or results for such systems.

However, given their computational complexity, existing approaches for adjusting the parameters of software applications are still inefficient in many situations, taking too much time and/or using too many computing resources, for example.

### SUMMARY

The embodiments here involve a parameter value search system providing various techniques for hybrid heuristic and meta-heuristic parameter value search for software applications that may operate in accordance with the following example embodiments.

An example embodiment of a method may comprise: generating sets of parameter values to form a parameter configuration space, wherein each set comprises parameter values for parameters of a system configuration associated with a software application; applying a set of input values to instances of the system configuration modified by each of the sets of parameter values in the parameter configuration space to identify sets of corresponding output values; determining, for each of the sets of parameter values in the parameter configuration space based on the set of input values and the respective set of corresponding output values, a respective input-value-to-output-value relationship, a respective variability, and a respective error; generating a test system configuration based on the system configuration and a particular set of parameter values, wherein the respective error associated with the particular set of parameter values is below a threshold; applying a heuristic to modify the test system configuration until a test input-value-to-output-value relationship is within a first tolerance of a target input-value-to-output-value relationship and a test variability is within a second tolerance of a target variability; and causing a computing system to execute in accordance with the modified test system configuration.

An example embodiment of a tangible, non-transitory computer readable medium may comprise instructions that, when executed, cause at least one processor to perform a set of operations comprising: generating sets of parameter values to form a parameter configuration space, wherein each set comprises parameter values for parameters of a system configuration associated with a software application; applying a set of input values to instances of the system configuration modified by each of the sets of parameter values in the parameter configuration space to identify sets of corresponding output values; determining, for each of the sets of parameter values in the parameter configuration space based on the set of input values and the respective set of corresponding output values, a respective input-value-to-output-value relationship, a respective variability, and a respective error; generating a test system configuration based on the system configuration and a particular set of parameter values, wherein the respective error associated with the particular set of parameter values is below a threshold; applying a heuristic to modify the test system configuration until a test input-value-to-output-value relationship is within a first tolerance of a target input-value-to-output-value relationship and a test variability is within a second tolerance of a target variability; and causing a computing system to execute in accordance with the modified test system configuration.

An example embodiment of a system may comprise: at least one processor; and tangible, non-transitory computer readable medium comprising instructions that, when executed, cause the at least one processor to perform a set of operations comprising: generating sets of parameter values to form a parameter configuration space, wherein each set comprises parameter values for parameters of a system configuration associated with a software application; applying a set of input values to instances of the system configuration modified by each of the sets of parameter values in the parameter configuration space to identify sets of corresponding output values; determining, for each of the sets of parameter values in the parameter configuration space based on the set of input values and the respective set of corresponding output values, a respective input-value-to-output-value relationship, a respective variability, and a respective error; generating a test system configuration based on the system configuration and a particular set of parameter values, wherein the respective error associated with the particular set of parameter values is below a threshold; applying a heuristic to modify the test system configuration until a test input-value-to-output-value relationship is within a first tolerance of a target input-value-to-output-value relationship and a test variability is within a second tolerance of a target variability; and causing a computing system to execute in accordance with the modified test system configuration.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 illustrates a simplified block diagram of an example computing device in accordance with certain embodiments.

FIG. 2 illustrates a simplified block diagram of an example parameter value search system in accordance with certain embodiments.

FIG. 3 illustrates a block diagram of data flow in an example parameter value search system in accordance with certain embodiments.

FIG. 4A illustrates a first example parameter configuration space in accordance with certain embodiments.

FIG. 4B illustrates a second example parameter configuration space in accordance with certain embodiments.

FIG. 4C illustrates a pseudo-code algorithm in accordance with certain embodiments.

FIG. 5 illustrates a flow chart in accordance with certain embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

This disclosure describes techniques for adjusting the parameters of a software application. More particularly, as discussed below, disclosed embodiments provide various techniques for hybrid heuristic and meta-heuristic parameter value search for software applications. The parameters of the software application may be adjusted by a parameter value search system, for example. For example, the parameter value search system may apply one or more techniques to search for parameter values that improve the behavior of the software application. In examples, parameters of a software application may be adjusted to alter the behavior of the software application, changing the characteristics of the outputs of the software application for a corresponding set of inputs. In some examples, the parameters of the software application may be adjusted to result in a relationship between input values and output values meeting a target criteria, such as a ratio or absolute difference, for example. In some examples, the parameters of the software application may be adjusted to achieve a target variability for the output values. Other criteria for adjustment of the parameters are possible.

Software applications which may benefit from adjustment of parameters may be found in a wide range of technical applications, including, for example, manufacturing quality control, computer networking systems, optical communication systems, integrated circuit design, etc. For example, a manufacturing quality control application may have parameters that are adjusted to maintain a thickness of protective coating to a desired thickness and within a variance specified by engineering tolerances. As another example, an optical communication system may have parameters that are adjusted to achieve a wavelength within a variance specified by engineering tolerances. Other applications would be apparent to those of ordinary skill in the art.

### II. Example Computing Device

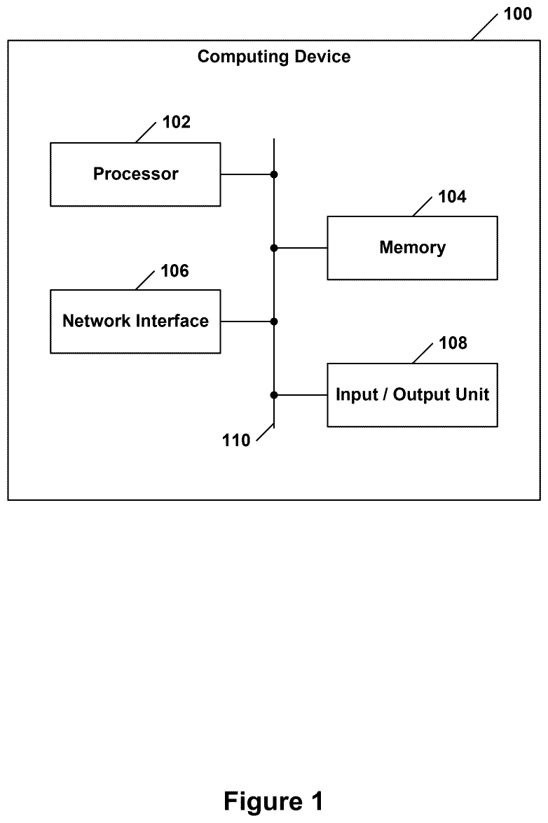

FIG. 1 is a simplified block diagram of an example computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

Memory 104 may include firmware, a kernel, and/or applications. The firmware may be program code used to boot or otherwise initiate some or all of computing device 100. The kernel may be an operating system, including modules for memory management, scheduling, and management of processes, input/output, and communication. The kernel may also include device drivers that allow the operating system to communicate with the hardware modules (e.g., memory units, networking interfaces, ports, and buses) of computing device 100. The applications may be one or more user-space software programs, such as web browsers or email clients, as well as any software libraries (e.g., scheduling algorithms and/or random number generators) used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support the embodiments herein. The exact physical location, connectivity, and configuration of these computing devices may be unknown and/or unimportant to client devices. Accordingly, the computing devices may be referred to as “cloud-based” devices that may be housed at various remote data center locations.

### III. Example Parameter Value Search System

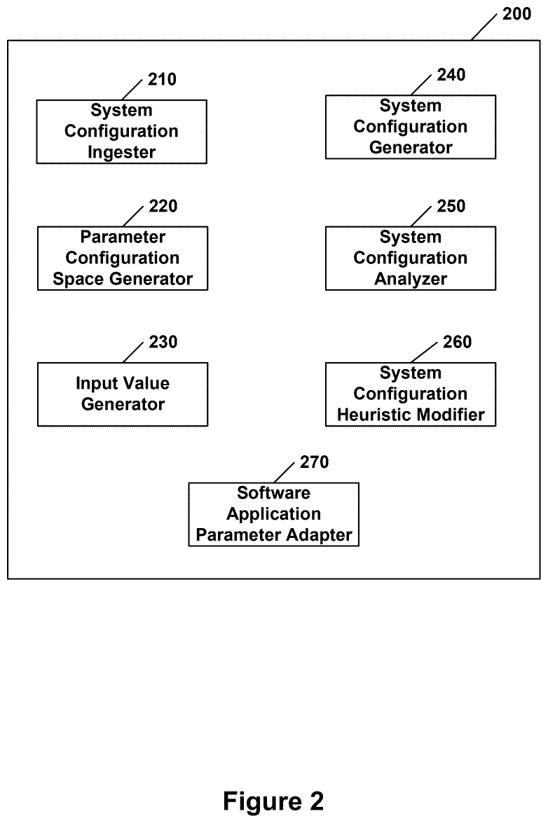

FIG. 2 illustrates a simplified block diagram of an example parameter value search system 200 in accordance with certain embodiments. The parameter value search system 200 includes a system configuration ingester 210, a parameter configuration space generator 220, an input value generator 230, a system configuration generator 240, a system configuration analyzer 250, a system configuration heuristic modifier 260, and a software application parameter adapter 270. The parameter value search system 200 may be implemented by and/or incorporate one or more computing devices, such as computing device 100, for example. In some examples, the parameter value search system 200 uses and/or is supported by multiple other computing devices, including, for example, cloud-based devices, to perform certain operations in parallel.

The parameter value search system 200, as discussed in more detail below, may apply one or more techniques to search for parameter values that improve the behavior of a software application. The applied techniques may include one or more various techniques for hybrid heuristic and meta-heuristic parameter value search for software applications. In examples, parameters of a software application may be adjusted to alter the behavior of the software application, changing the characteristics of the outputs of the software application for a corresponding set of inputs. In some examples, the parameters of the software application may be adjusted to result in a metric conforming to a threshold with respect to a target criteria. Such conformance of the metric after adjustment of the parameters of the software application may result in improved operation of the software application, for example.

The system configuration ingester 210 ingests, receives, reads, or otherwise obtains data representing a system configuration associated with a software application. The system configuration ingester 210 may be implemented by and/or incorporate one or more computing devices, such as computing device 100, for example. In examples, the data representing the system configuration obtained by the system configuration ingester 210 may be referred to as the initial system configuration. In examples, the system configuration specifies a behavior of the software application. The behavior of the software application may be based on parameters associated with the software application, for example. The parameters may have corresponding initial values, for example, which are the values that the software application uses by default and/or as currently configured.

In examples, the system configuration includes, specifies, and/or describes components of, used by, managed by, and/or controlled by the software application. A component may respond to one or more inputs. A component may provide one or more outputs. An output of a component may be provided according to functionality associated with the component. An output of a component may be provided according to one or more parameters associated with the component. In some examples, the system configuration includes, specifies, and/or describes relationships between components. For example, the system configuration may specify an arrangement of components including that one or more outputs of a particular components are connected to one or more inputs of other components. In examples, the components include, describe, and/or correspond to steps of a process.

In examples, the system configuration ingester 210 may convert, translate, or otherwise process the data into a format or representation understood by the parameter value search system 200. For example, the data representing the system configuration obtained by the system configuration ingester 210 may be specified in a schema, configuration file, settings file, collection file, sample file, database, table, etc.

The parameter configuration space generator 220 generates, calculates, determines, or otherwise produces a parameter configuration space. The parameter configuration space generator 220 may be implemented by and/or incorporate one or more computing devices, such as computing device 100, for example. In examples, the parameter configuration space may be based on parameters associated with the software application and specified in a system configuration. The system configuration may be provided by the system configuration ingester 210, for example. The parameter configuration space may establish a topography of an error domain using a crude search, for example. For example, a randomized (such as a uniform and flat search), non-parametric (such as models which make no assumption about the parameters or whether they have a particular profile), or naïve (such as Naïve Bayes probabilistic algorithm) search may be used.

In some examples, the parameter configuration space generator 220 produces the entire parameter configuration space before providing it to the system configuration generator 240 (discussed below) to generate instances of the system configuration for the system configuration analyzer 250 (discussed below). For example, the parameter configuration space generator 220 may generate all of the values defining the parameter configuration space before providing the parameter configuration space to the system configuration generator 240 to generate system configuration instances for the system configuration analyzer 250. In some examples, the parameter configuration space generator 220 works in conjunction with the system configuration generator 240 and the system configuration analyzer 250. For example, the parameter configuration space generator 220 may generate only a portion of the parameter configuration space before providing it to the system configuration generator 240 to generate corresponding system configuration instances for the system configuration analyzer 250. The system configuration analyzer 250 may then begin searching the partial parameter configuration space using the system configuration instances and provide metrics back to the parameter configuration space generator 220 so that the parameter configuration space generator 220 can generate more of the parameter configuration space based on the provided metrics, for example. In this way, the parameter configuration space generator 220 and the system configuration analyzer 250 can iteratively perform a search of the parameter configuration space.

In some examples, the parameter configuration space generator 220 generates a parameter configuration space by altering various permutations of values corresponding to one or more of the parameters associated with the software application. In examples, the parameter configuration space generator 220 may start with a set of initial values for the parameters and then determine various permutations with adjustments made to one or more of the initial values to produce a parameter configuration space. The set of initial values for the parameters may be defined in the initial system configuration obtained by the system configuration ingester 210, for example.

In some examples, the adjustments may include altering a parameter value by a constant amount, user-specified amount, a random amount, a percentage, etc. For example, a value associated with a particular parameter may be adjusted to be larger or smaller in increments of 0.25, 0.5, 1, 2, 5, 10, 100, etc. As another example, a value associated with a particular parameter may be adjusted to be larger or smaller by multiplying or dividing it by 2, 4, 5, 10, 100, etc. As another example, a value associated with a particular parameter may be adjusted to be larger or smaller by 1%, 5%, 10%, 20%, or 50%, for example. In some examples, the way that a particular parameter value is adjusted is non-linear, selected from a set of different adjustment amounts, random, etc. As an example, a value associated with a particular parameter may be adjusted by non-linear moves such as the product of the difference between a metric and a target and an associated weight. In some examples, the way that a particular parameter value is adjusted is pre-determined or specified by a user. In some examples, each parameters may be adjusted in a different way or a way independent of how other parameters are adjusted. Other types or amounts of adjustments are possible.

In some examples, parameters may be associated with constraints on the possible range of values. For example, a particular parameter may be associated with a constraint indicating its value must always be greater than 0. As another example, a particular parameter may be associated with a constraint indicating that its value be within the range −1 to 1. As another example, a particular parameter may be associated with a constraint of being a Boolean or switch with values represented as either 0 or 1. As another example, a particular parameter may be associated with a constraint indicating it is an integer value. As another example, a particular parameter may be associated with a constraint indicating its value is limited to a predetermined set of possible values. Other constraints are possible.

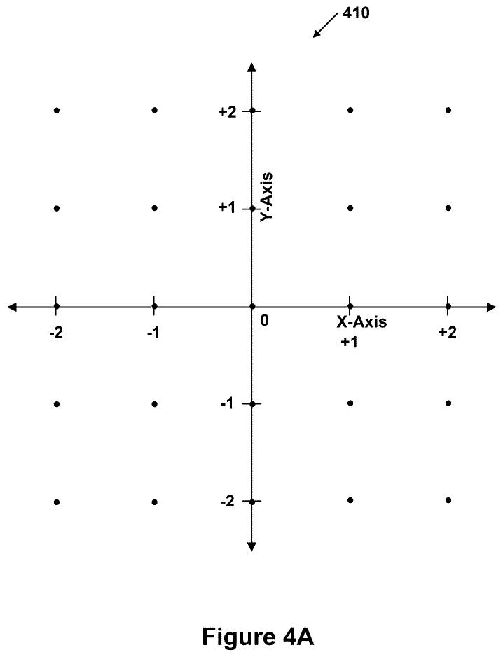

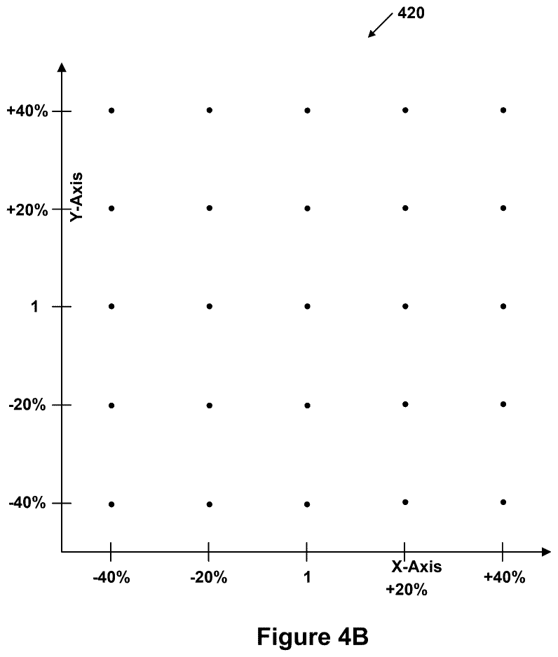

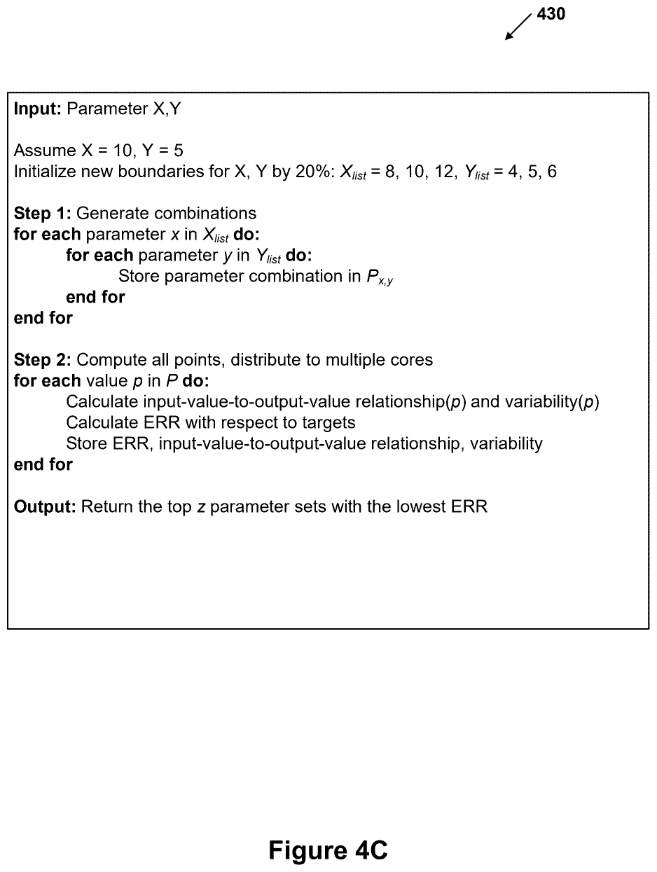

As a simple exemplary illustration of a parameter configuration space, consider a software application that has 2 parameters, X and Y. In this example, X and Y both have an initial value of 0. The parameter configuration space generator 220 may generate the parameter configuration space by assembling permutations of values for X and Y by, for example, altering X and Y each by +/−1. Thus, the determined parameter configuration space may include the set of permutations: [(0, 0), (1, 0), (0, 1), (1, 1), (−1, 0), (0, −1), (−1, −1), (1, −1), (−1, 1)]. Other example parameter configuration spaces are discussed below with respect to FIGS. 4A-4B.

The input value generator 230 generates, calculates, determines, or otherwise produces a set of input values. The input value generator 230 may be implemented by and/or incorporate one or more computing devices, such as computing device 100, for example. In examples, the set of input values represent possible values to be provided as input to the software application. For example, the set of input values may be all possible input values to the software application. As another example, the set of input values may be a subset of all possible input values to the software application.

The system configuration generator 240 generates, determines, constructs, or otherwise produces system configuration instances. The system configuration generator 240 may be implemented by and/or incorporate one or more computing devices, such as computing device 100, for example. In examples, the system configuration generator 240 provides one or more instances of the initial system configuration provided by the system configuration ingester 210 where each instance includes one or more altered parameter values from of the initial system configuration. For example, the different parameter values used to generate each instance may be selected from a parameter configuration space, such as the parameter configuration space provided by the parameter configuration space generator 220, for example.

The system configuration analyzer 250 analyzes, executes, simulates, or otherwise determines outputs resulting from applying an input to a system configuration. The system configuration analyzer 250 may be implemented by and/or incorporate one or more computing devices, such as computing device 100, for example. In some examples, the system configuration analyzer 250 applies one or more sets of inputs provided by the input value generator 230 to determine the outputs. Each input in the set of inputs may be iteratively applied or applied in parallel to instances of the system configuration, for example. In examples, the outputs are determined according to the behavior specified by the system configuration. In some examples, the system configuration analyzer 250 applies inputs to one or more of the system configuration instances provided by the system configuration generator 240 to determine the output. In some examples, the system configuration analyzer 250 applies inputs to the initial system configuration to determine the outputs. For example, the system configuration analyzer 250 may apply all possible sets of input values to the initial system configuration to determine corresponding sets of output values. As another example, the system configuration analyzer 250 may apply, to each system configuration instance provided by the system configuration generator 240, all possible sets of input values as provided by the input value generator 230 to determine, for each system configuration instance, sets of output values.

In some examples, the system configuration analyzer 250 applies the input values to each system configuration sequentially. In some examples, the system configuration analyzer 250 applies the input values to each system configuration at least partially in parallel. For example, the system configuration analyzer 250 is supported by a cluster of 50 computing devices and divides the system configuration instances to be analyzed across the 50 computing devices and the input values are then applied by the 50 computing devices in parallel. As another example, the system configuration analyzer 250 may include 1000 virtual machines and may apply a different input value to the same system configuration on each of the 1000 virtual machines in parallel. Other combinations of distributing system configurations and selecting inputs to apply across multiple computing devices are possible.

In examples, the system configuration analyzer 250 generates, calculates, determines, or otherwise produces metrics associated with outputs resulting from applying inputs to a system configuration.

In some examples, a metric produced by the system configuration analyzer 250 includes a relationship between input values and corresponding output values, which may also be referred to as an input-value-to-output-value relationship. In examples, the input-value-to-output-value relationship may be a ratio or an inverse ratio. For example, the input-value-to-output-value relationship may be determined by determining the number of input values in the set of input values divided by a weighted average of the output values. As another example, the input-value-to-output-value relationship may be determined based on a value associated with each output value divided by a value associated with the number of input values. As another example, some input values in the sets of input values may belong to a sub-group whose impact on a corresponding output value is based not on a frequency or occurrence of those input values, but by an independent weight or set of weights representing their frequency and occurrence in the larger set of input values. Other input-value-to-output value relationships are possible.

In some examples, a metric produced by the system configuration analyzer 250 includes a variability. In examples, the variability may be, or relate to, a statistical measure of volatility of the outputs (or values associated with the outputs). The variability may be related to a standard deviation of the output values, or any other measure of the spread of the distribution of the output values (or values associated with the outputs), for example. For example, a low variability may indicate that the output values are more consistent with each other. As another example, a high variability may indicate that values associated with the outputs are less consistent with each other. In some examples, the variability includes a metric based on, associated with, and/or indicating a volatility. For example, the variability may be a proxy for a 95% confidence interval range for the standard error of an input-value-to-output-value relationship.

In some examples, a metric produced by the system configuration analyzer 250 includes an error value. The error value may be based on, calculated, or otherwise determined based on a target value. In some examples, multiple error values, each associated with a same or different target value may be determined. In some examples, an error value is associated with, based on, calculated from, or otherwise determined using one or more other metrics produced by the system configuration analyzer 250. For example, an error value may be determined based on a difference between a relationship between input values and corresponding output values and a target value. As another example, an error value may be determined based on a difference between a variability metric and a target variability value. As another example, an error value may be calculated based on both a difference between a determined input-value-to-output-value relationship and a first target value and a difference between a variability and a second target value. In some examples, the error is determined by an objective function. For example, an objective function may specify that the error is determined by: the square root of the square of the difference between a first determined metric and a first target value plus the square root of the square of the difference between a second determined metric and a second target value. As another example, the object function may specify that the error is determined by: the absolute value of the difference between a first determined metric and a first target value plus the absolute value of the difference between a second determined metric and a second target value. Other ways of determining error values are possible.

FIG. 4C illustrates an example pseudo-code algorithm 430 for producing a parameter configuration space and analyzing system configuration instances in accordance with example embodiments. The example algorithm 430 takes parameters X and Y as inputs. The parameters may be specified as part of an initial system configuration ingested by the system configuration ingester 210, for example. For the purposes of the example algorithm, X is shown as equal to 10 and Y is shown as equal to 5. In the example algorithm 430, new boundaries for parameters X and Y are initialized by 20% as part of generating a parameter configuration space resulting in a list of X parameters containing 8, 10, and 12 and a list of Y parameters containing 4, 5, and 6. At Step 1 of the example algorithm 430, combinations of the parameter values are generated using the list of X parameters and the list of Y parameters. The each combination is stored in variable P, as shown. The variable P may be considered a parameter configuration space, for example. The list of values for each parameter and the combinations may be generated by the parameter configuration space generator 220, for example. At Step 2 of the example algorithm 430, calculations are performed at each point (corresponding to a particular combination) in P. In the example algorithm 430, the calculations for each value p in P are distributed across multiple processing cores. For each value p in P, an input-value-to-output-value relationship and a variability are calculated and stored. In addition, for each value p in P an error (ERR) metric is determined based on target values and stored. The input-value-to-output-value relationship, variability, and error may be calculated by the system configuration analyzer 250, for example. As output, the example algorithm 430 provides the top z parameter sets with the lowest ERR.

The system configuration heuristic modifier 260 runs, executes, or otherwise applies a heuristic to a system configuration. The system configuration heuristic modifier 260 may be implemented by and/or incorporate one or more computing devices, such as computing device 100, for example. In examples, a heuristic is a problem solving technique, often used for discrete optimization. Different heuristics may be tailored to a narrow set of problems in a domain, for example.

In examples, the system configuration heuristic modifier 260 applies a heuristic to more than one system configuration. A system configuration that a heuristic is applied to may be referred to as a test system configuration, for example. In examples, the test system configuration (or test system configurations) may be one or more system configurations selected from the system configuration instances provided by the system configuration generator 240. In some examples, the one or more system configuration instances to be used as test system configurations are selected based on the analysis of the system configuration analyzer 250. In some examples, the test system configuration is generated by the system configuration generator 240 based on adjusted parameter values selected by the system configuration analyzer 250. For example, the system configuration analyzer 250 may determine an error associated with each of the system configuration instances and one or more sets of adjusted parameters are selected based on an error associated with the corresponding metric conforming to a threshold, such as being within a range, being above the threshold, or being below the threshold. In some examples, the system configuration heuristic modifier 260 directly uses a system configuration instance that was selected by the system configuration analyzer 250 as a test system configuration. It should be understood that many heuristics can become stuck in a false minima and be unable to find a preferred or acceptable solution, particularly in large systems. By starting such heuristics from one of the selected sets of adjusted parameters, the efficiency and effectiveness of the heuristics can be improved.

In examples the heuristic may be one of a variety of heuristics, such as Nelder-Mead simplex algorithm, Powell's method, simulated annealing, Tabu-search algorithm, gradient descent, and/or hill climbers, for example. In some cases, gradient descent may be used when the system's objective function is differentiable. In some examples, the system configuration heuristic modifier 260 applies more than one heuristic to the system configuration.

In examples, the heuristic modifies the parameters of the test system configuration until a metric of the test system configuration conforms to a threshold with a target value, such as being within a range, being above the threshold, or being below the threshold, for example. In some examples, the heuristic modifies the parameters of the test system configuration until multiple metrics conform to a threshold with corresponding target values.

In some examples, the system configuration heuristic modifier 260 applies the each heuristic to the test system configuration sequentially. In some examples, the test system configuration is reset back to its original parameter values for each heuristic. In some examples, the system configuration heuristic modifier 260 applies the heuristics to separate instances of the test system configuration at least partially in parallel. For example, the system configuration heuristic modifier 260 may be supported by a cluster computing devices and divides the copies of the test system configuration to be modified across the computing devices in the cluster and applies a different heuristic to each copy of the test system configuration. As another example, the system configuration heuristic modifier 260 may distribute the calculation of metrics across virtual machines managed by the system configuration heuristic modifier 260 to check for conformity with the corresponding target value for the metric. Other combinations of distributing the application of heuristics to test system configuration(s) are possible.

The software application parameter adapter 270 adapts, updates, alters, or otherwise modifies parameters of a software application. The software application parameter adapter 270 may be implemented by and/or incorporate one or more computing devices, such as computing device 100, for example. In examples, the software application parameter adapter may modify one or more parameters for a software application based on the modified parameters of the test system configuration determined by the system configuration heuristic modifier 260.

In examples, after modifying the parameters of the software application, the software application parameter adapter 270 may cause a computing system to execute the software application with the modified parameters. For example, the software application with the modified parameters may be run, initiated, executed, or otherwise made to perform its intended purpose. In some examples, the modified software application may be tested to determine if the actual behavior matches that determined by the parameter value search system 200. For example, empirical testing can be employed to evaluate the behavior of the modified software application using various combinations of input values and analyzing the outputs against expected and/or target metric values.

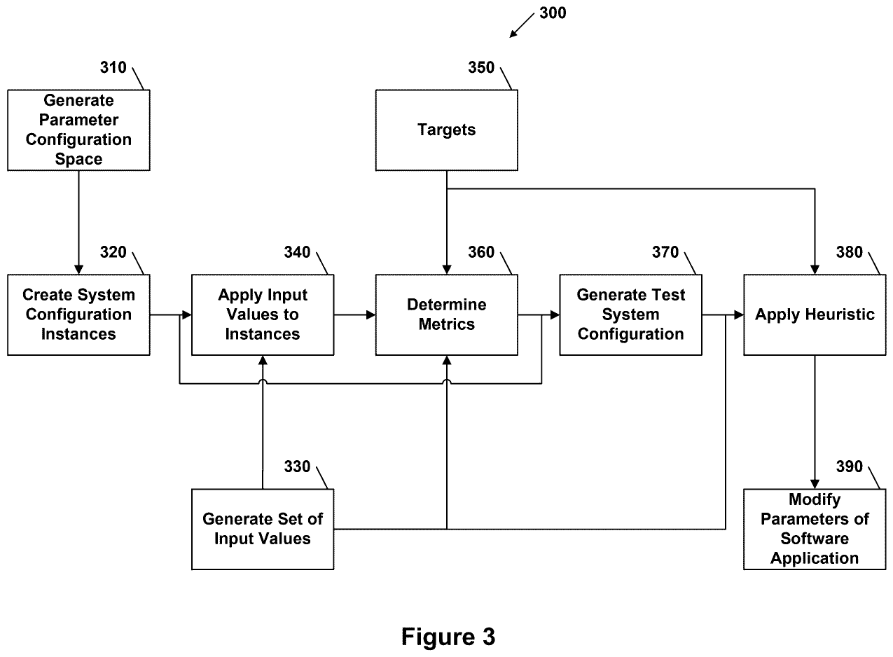

FIG. 3 illustrates a block diagram of data flow 300 in an example parameter value search system in accordance with certain embodiments. The parameter value search system may be similar to the example parameter value search system 200, for example.

At block 310, a parameter configuration space is generated. The parameter configuration space may be generated by a parameter configuration space generator similar to the parameter configuration space generator 220 discussed above, for example. In examples, the parameter configuration space may be generated based on a system configuration received from a system configuration ingester similar to the system configuration ingester 210 discussed above, for example. In examples, the parameter configuration space may be provided to a system configuration generator similar to the system configuration generator 240 discussed above, for example.

At block 320, system configuration instances are created. The system configuration instances may be created by a system configuration generator similar to the system configuration generator 240 discussed above, for example. In examples, the system configuration instances may be created based on a system configuration received from a system configuration ingester similar to the system configuration ingester 210 discussed above, for example. In examples, the system configuration instances may be provided to a system configuration analyzer similar to the system configuration analyzer 250 discussed above, for example. In examples, the system configuration instances may be provided to a system configuration heuristic modifier similar to the system configuration heuristic modifier 260 discussed above, for example.

At block 330, sets of input values are generated. The sets of input values may be generated by an input value generator similar to the input value generator 230 discussed above, for example. In examples, the sets of input values may be provided to a system configuration analyzer similar to the system configuration analyzer 250 discussed above, for example. In examples, the sets of input values may be provided to a system configuration heuristic modifier similar to the system configuration heuristic modifier 260, for example.

At block 340, the sets of input values are applied to the system configuration instances. The sets of input values may be applied to the system configuration instances by a system configuration analyzer similar to the system configuration analyzer 250 discussed above, for example. Applying the sets of input values to the system configuration instances may generate corresponding sets of respective output values. In examples, the sets of input values may be received from an input value generator similar to the input value generator 230 discussed above, for example. The system configuration instances may be received from a system configuration generator similar to the system configuration generator 240 discussed above, for example.

At block 350, targets are determined. In examples, one or more targets may be determined. For example, a target may be a target input-value-to-output-value relationship. As another example, a target may be a target variability. In some examples, the targets may be determined by being specified, provided, obtained from and/or otherwise received from a user. For example, a user may provide one or more targets through a user interface of a parameter value search system similar to the parameter value search system 200 discussed above, for example. In some examples, the targets may be determined from pre-determined targets. In some examples, one or more targets may be defaulted to a slack state of its intended metric, prior to adjustment while other targets are pursued. In examples, the targets may be provided to a system configuration analyzer similar to the system configuration analyzer 250 discussed above, for example. In some examples, the targets may be provided to a system configuration heuristic modifier similar to the system configuration heuristic modifier 260 discussed above, for example.

At block 360, metrics are determined. In examples, one or more metrics may be determined. For example, a metric may be an input-value-to-output-value relationship. As another example, a metric may be a variability. As another example, a metric may be an error. The metrics may be determined by a system configuration analyzer similar to the system configuration analyzer 250 discussed above, for example. In some examples, a metric may be determined based on a set of input values. In examples, the set of inputs may be received from an input value generator similar to the input value generator 230 discussed above, for example. In some examples, a metric may be determined based on output values generated from applying sets of input values to a system configuration. In some examples, a metric may be determined based on targets.

At block 370, a test system configuration is generated. The test system configuration may be generated by a system configuration generator similar to the system configuration generator 240 discussed above, for example. In examples the test system configuration may be generated based on a system configuration received from a system configuration ingester similar to the system configuration ingester 210 discussed above, for example. In examples, the test system configuration may be based on metrics determined by a system configuration analyzer similar to the system configuration analyzer 250 discussed above, for example. For example, the test system configuration may be generated based on a set of parameter values that modified a system configuration and resulted in an error metric that conformed to a threshold. In examples, the test system configuration may be provided to a system configuration heuristic modifier similar to the system configuration heuristic modifier 260 discussed above, for example.

At block 380, a heuristic is applied to the test system configuration. The heuristic may be applied to the test system configuration by a system configuration heuristic modifier similar to the system configuration heuristic modifier 260 discussed above, for example. In examples, the test system configuration may be received from a system configuration generator similar to the system configuration generator 240 discussed above, for example. Applying the heuristic to the test system configuration may be based on sets of input values, for example. In examples, sets of input values may be received from an input value generator similar to the input value generator 230 discussed above, for example. Applying the heuristic to the test system configuration may be based on targets, for example. In some examples, applying the heuristic to the test system configuration generates a modified test system configuration. In some examples, the modified test system configuration may be provided to a software application parameter adapter similar to the software application parameter adapter 270 discussed above, for example.

At block 390, the parameters of the software application are modified. The parameters of the software application may be modified by a software application parameter adapter similar to the software application parameter adapter 270 discussed above, for example. In examples, the parameters of the software application may be modified based on a modified test system configuration. The modified test system configuration may be received from a system configuration heuristic modifier similar to the system configuration heuristic modifier 260 discussed above, for example.

One possible way of formally characterizing example embodiments of FIGS. 2 and 3 may be as follows. Consider a software application as having parameters p, taking inputs i, and producing outputs o (each of these variables may be vectors of the same or different sizes). The relationship between p, i, and o can be expressed as o=f(p, i) for some function f. A goal of example embodiments herein is to determine values of p for which there is a given relationship r(i, o) between i and o. Here, r may be such that the expected value of o given a sufficiently high number of samples of values of i has a specific ratio and/or the variability of o given a sufficiently high number of samples of values of i is less than a specific threshold value (for example, such that the variability is acceptably close to 0). Other characterizations may be possible.

FIGS. 4A and 4B illustrate, respectively, a first example parameter configuration space 410 and a second example parameter configuration space 420 in accordance with certain embodiments. Both the first example parameter configuration space 410 and the second example parameter configuration space 420 are show with two parameters, X and Y for clarity of explanation. However, it should be understood that a parameter configuration space may include many more parameters.

In the first example parameter configuration space 410 shown in FIG. 4A, the initial values of X and Y are 0. The first example parameter configuration space 410 further includes permutations of adjusted values for these parameters. In this example, X and Y have each been adjusted by constant values, +/−1 and +/−2, as represented by the points in the first example parameter configuration space 410. However, as discussed above, it should be understood that other adjustments are possible. Further, it should be understood that each parameter may be adjusted using a different technique and/or in a different amount.

In the second example parameter configuration space 420 shown in FIG. 4B, the initial values of X and Y are 1. In addition, X and Y have a constraint of being positive numbers. The second example parameter configuration space 420 further includes permutations of adjusted values for these parameters. In this example, X and Y have each been adjusted by +/−20% and +/−40% relative to their initial values, as represented by the points in the second example parameter configuration space 420. However, as discussed above, it should be understood that other adjustments are possible. Further, it should be understood that teach parameter may be adjusted using a different technique and/or in a different amount.

### IV. Example Operations

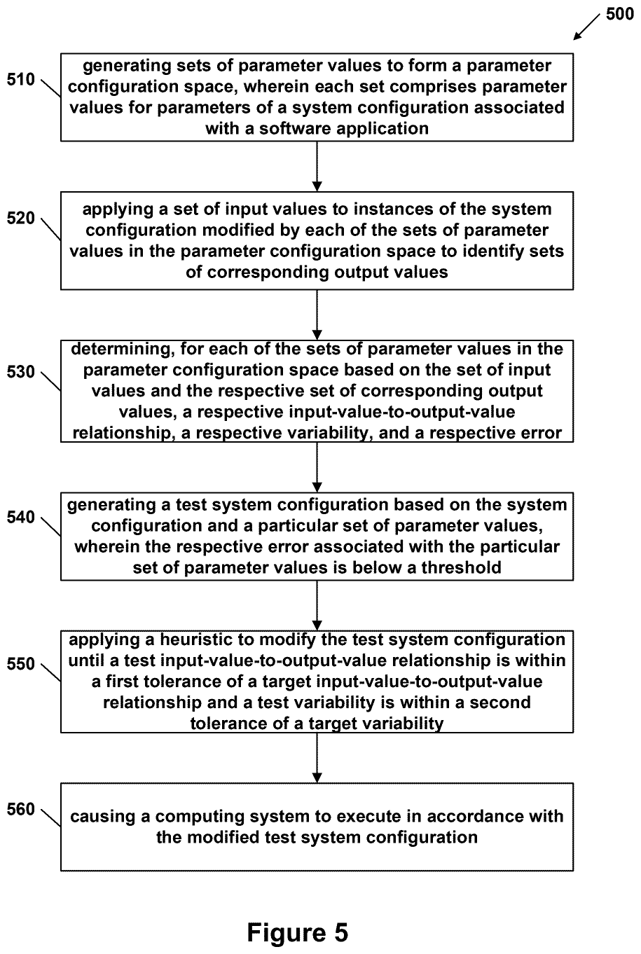

FIG. 5 illustrates a flow chart 500 in accordance with certain embodiments. The process illustrated by flow chart 500 may be carried out by one or more computing devices, such as computing device 100, for example. In some examples, flow chart 500 may include fewer or more steps or blocks than those expressly illustrated or otherwise disclosed herein. Furthermore, respective steps or blocks of flow chart 500 may be performed in different order as compared to the order illustrated in FIG. 5, and may be combined with any other features described herein.

Block 510 may involve generating sets of parameter values to form a parameter configuration space, wherein each set comprises parameter values for parameters of a system configuration associated with a software application.

Block 520 may involve applying a set of input values to instances of the system configuration modified by each of the sets of parameter values in the parameter configuration space to identify sets of corresponding output values.

Block 530 may involve determining, for each of the sets of parameter values in the parameter configuration space based on the set of input values and the respective set of corresponding output values, a respective input-value-to-output-value relationship, a respective variability, and a respective error.

Block 540 may involve generating a test system configuration based on the system configuration and a particular set of parameter values, wherein the respective error associated with the particular set of parameter values is below a threshold.

Block 550 may involve applying a heuristic to modify the test system configuration until a test input-value-to-output-value relationship is within a first tolerance of a target input-value-to-output-value relationship and a test variability is within a second tolerance of a target variability.

Block 560 may involve causing a computing system to execute in accordance with the modified test system configuration.

In some implementations, the process of flow chart 500 may include obtaining the system configuration, wherein the system configuration specifies a behavior of the software application, wherein the behavior of the software application is based on the parameters associated with software application; generating the set of input values based on the system configuration; and applying each of the set of input values to the system configuration to identify the set of corresponding output values according to the behavior specified by the system configuration.

In some implementations, the parameters have corresponding initial values, wherein the generated sets of parameter values are based on adjustments to one or more of the initial values of the corresponding parameters of the system configuration.

In some implementations, the adjustments are selected to be at least 20% of the corresponding initial value.

In some implementations, the system configuration further comprises components, wherein each component responds to an input and provides an output according to functionality associated with the component and one or more parameters associated with the component.

In some implementations, the system configuration comprises relationships between the components, wherein outputs of components are provided as inputs to other components according to the relationships.

In some implementations, the components comprise steps of a process.

In some implementations, applying the set of input values to instances of the system configuration modified by each of the sets of parameter values is performed in parallel for each instance.

In some implementations, the respective error associated with a set of parameter values is determined using an error function, wherein the error function, wherein the error function is based on a difference between (i) a ratio of the input values to the output values for the set of parameter values, and (ii) a target ratio of the input values to the output values, wherein the error function is further based on a difference between (i) a variance index for the set of parameter values and (ii) a target variance index. In some examples, the error function may be sqrt((ratio of input value to output value-target ratio of input value to output value)²)+sqrt((variance index−target variance index)²).

In some implementations, the process of flow chart 500 may include generating a plurality of test system configuration, wherein each test system configuration of the plurality of tests system configurations is based on the system configuration and a corresponding set of parameter values in a plurality of sets of parameter values, wherein the respective error associated with each set of parameter values in the plurality of sets of parameter values is below the threshold; and applying the heuristic to modify each test system configuration of the plurality of test system configurations until a respective test input-value-to-output-value relationship is within the first tolerance of the target input-value-to-output-value relationship and a respective test variability is within the second tolerance of the target variability.

In some implementations, the process of flow chart 500 may include applying a second heuristic to modify a second test system configuration until a second test input-value-to-output-value relationship is within the first tolerance of the target input-value-to-output-value relationship and a second test variability is within the second tolerance of the target variability, wherein applying the heuristic and the second heuristic is performed in parallel.

In some implementations, the heuristic comprises at least one of: (i) Nelder-Mead simplex algorithm; (ii) Powell's method; (iii) simulated annealing; (iv) Tabu-search algorithm; (v) gradient descent; or (vi) hill climbers.

### V. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
generating sets of parameter values to form a parameter configuration space, wherein each set comprises parameter values for parameters of a system configuration associated with a software application;
applying a set of input values to instances of the system configuration modified by each of the sets of parameter values in the parameter configuration space to identify sets of corresponding output values;
determining, for each of the sets of parameter values in the parameter configuration space based on the set of input values and the respective set of corresponding output values, a respective input-value-to-output-value relationship, a respective variability, and a respective error;
generating a test system configuration based on the system configuration and a particular set of parameter values, wherein the respective error associated with the particular set of parameter values is below a threshold;
applying a heuristic to modify the test system configuration until a test input-value-to-output-value relationship is within a first tolerance of a target input-value-to-output-value relationship and a test variability is within a second tolerance of a target variability; and
causing a computing system to execute in accordance with the modified test system configuration.

2. The method of claim 1, further comprising:
obtaining the system configuration, wherein the system configuration specifies a behavior of the software application, wherein the behavior of the software application is based on the parameters associated with software application;
generating the set of input values based on the system configuration; and
applying each of the set of input values to the system configuration to identify the set of corresponding output values according to the behavior specified by the system configuration.

3. The method of claim 1, wherein the parameters have corresponding initial values, wherein the generated sets of parameter values are based on adjustments to one or more of the initial values of the corresponding parameters of the system configuration.

4. The method of claim 3, wherein the adjustments are selected to be at least 20% of the corresponding initial value.

5. The method of claim 1, wherein the system configuration further comprises components, wherein each component responds to an input and provides an output according to functionality associated with the component and one or more parameters associated with the component.

6. The method of claim 5, wherein the system configuration comprises relationships between the components, wherein outputs of components are provided as inputs to other components according to the relationships.

7. The method of claim 5, wherein the components comprise steps of a process.

8. The method of claim 1, wherein applying the set of input values to instances of the system configuration modified by each of the sets of parameter values is performed in parallel for each instance.

9. The method of claim 1, wherein the respective error associated with a set of parameter values is determined using an error function, wherein the error function, wherein the error function is based on a difference between (i) a ratio of the input values to the output values for the set of parameter values, and (ii) a target ratio of the input values to the output values, wherein the error function is further based on a difference between (i) a variance index for the set of parameter values and (ii) a target variance index.

10. The method of claim 1, further comprising:
generating a plurality of test system configuration, wherein each test system configuration of the plurality of tests system configurations is based on the system configuration and a corresponding set of parameter values in a plurality of sets of parameter values, wherein the respective error associated with each set of parameter values in the plurality of sets of parameter values is below the threshold; and
applying the heuristic to modify each test system configuration of the plurality of test system configurations until a respective test input-value-to-output-value relationship is within the first tolerance of the target input-value-to-output-value relationship and a respective test variability is within the second tolerance of the target variability.

11. The method of claim 1, further comprising:
applying a second heuristic to modify a second test system configuration until a second test input-value-to-output-value relationship is within the first tolerance of the target input-value-to-output-value relationship and a second test variability is within the second tolerance of the target variability, wherein applying the heuristic and the second heuristic is performed in parallel.

12. The method of claim 1, wherein the heuristic comprises at least one of: (i) Nelder-Mead simplex algorithm; (ii) Powell's method; (iii) simulated annealing; (iv) Tabu-search algorithm; (v) gradient descent; or (vi) hill climbers.

13. A tangible, non-transitory computer readable medium comprising instructions that, when executed, cause at least one processor to perform a set of operations comprising:
generating sets of parameter values to form a parameter configuration space, wherein each set comprises parameter values for parameters of a system configuration associated with a software application;
applying a set of input values to instances of the system configuration modified by each of the sets of parameter values in the parameter configuration space to identify sets of corresponding output values;
determining, for each of the sets of parameter values in the parameter configuration space based on the set of input values and the respective set of corresponding output values, a respective input-value-to-output-value relationship, a respective variability, and a respective error;
generating a test system configuration based on the system configuration and a particular set of parameter values, wherein the respective error associated with the particular set of parameter values is below a threshold;
applying a heuristic to modify the test system configuration until a test input-value-to-output-value relationship is within a first tolerance of a target input-value-to-output-value relationship and a test variability is within a second tolerance of a target variability; and
causing a computing system to execute in accordance with the modified test system configuration.

14. The tangible, non-transitory computer readable medium of claim 13, wherein the parameters have corresponding initial values, wherein the generated sets of parameter values are based on adjustments to one or more of the initial values of the corresponding parameters of the system configuration.

15. The tangible, non-transitory computer readable medium of claim 13, wherein the set of operations further comprise:
generating a plurality of test system configuration, wherein each test system configuration of the plurality of tests system configurations is based on the system configuration and a corresponding set of parameter values in a plurality of sets of parameter values, wherein the respective error associated with each set of parameter values in the plurality of sets of parameter values is below the threshold; and
applying the heuristic to modify each test system configuration of the plurality of test system configurations until a respective test input-value-to-output-value relationship is within the first tolerance of the target input-value-to-output-value relationship and a respective test variability is within the second tolerance of the target variability.

16. The tangible, non-transitory computer readable medium of claim 13, wherein the set of operations further comprise:
applying a second heuristic to modify a second test system configuration until a second test input-value-to-output-value relationship is within the first tolerance of the target input-value-to-output-value relationship and a second test variability is within the second tolerance of the target variability, wherein applying the heuristic and the second heuristic is performed in parallel.

17. A system comprising:
at least one processor; and
tangible, non-transitory computer readable medium comprising instructions that, when executed, cause the at least one processor to perform a set of operations comprising:
generating sets of parameter values to form a parameter configuration space, wherein each set comprises parameter values for parameters of a system configuration associated with a software application;
applying a set of input values to instances of the system configuration modified by each of the sets of parameter values in the parameter configuration space to identify sets of corresponding output values;
determining, for each of the sets of parameter values in the parameter configuration space based on the set of input values and the respective set of corresponding output values, a respective input-value-to-output-value relationship, a respective variability, and a respective error;
generating a test system configuration based on the system configuration and a particular set of parameter values, wherein the respective error associated with the particular set of parameter values is below a threshold;
applying a heuristic to modify the test system configuration until a test input-value-to-output-value relationship is within a first tolerance of a target input-value-to-output-value relationship and a test variability is within a second tolerance of a target variability; and
causing a computing system to execute in accordance with the modified test system configuration.

18. The system of claim 17, wherein the parameters have corresponding initial values, wherein the generated sets of parameter values are based on adjustments to one or more of the initial values of the corresponding parameters of the system configuration.

19. The system of claim 17, wherein the set of operations further comprise:
generating a plurality of test system configuration, wherein each test system configuration of the plurality of tests system configurations is based on the system configuration and a corresponding set of parameter values in a plurality of sets of parameter values, wherein the respective error associated with each set of parameter values in the plurality of sets of parameter values is below the threshold; and
applying the heuristic to modify each test system configuration of the plurality of test system configurations until a respective test input-value-to-output-value relationship is within the first tolerance of the target input-value-to-output-value relationship and a respective test variability is within the second tolerance of the target variability.

20. The system of claim 17, wherein the set of operations further comprise:
applying a second heuristic to modify a second test system configuration until a second test input-value-to-output-value relationship is within the first tolerance of the target input-value-to-output-value relationship and a second test variability is within the second tolerance of the target variability, wherein applying the heuristic and the second heuristic is performed in parallel.
